(19) United States
(12) Patent Application Publication
(10) Pub. No.: US 2014/0108432 A1
(43) Pub. Date: Apr. 17, 2014

(54) METHOD AND APPARATUS OF RECOMMENDING POPULAR ACCOUNTS IN SNS SYSTEM

(71) Applicant: TENCENT TECHNOLOGY (SHENZHEN) COMPANY LIMITED, Shenzhen City (CN)

(72) Inventors: YU FAN, Shenzhen City (CN); JUN-JUN YAO, Shenzhen City (CN); YING-JIE WO, Shenzhen City (CN); QING-LING YAN, Shenzhen City (CN); CONG WANG, Shenzhen City (CN)

(73) Assignee: TENCENT TECHNOLOGY (SHENZHEN) COMPANY LIMITED, Shenzhen City (CN)

(21) Appl. No.: 14/138,003

(22) Filed: Dec. 20, 2013

Related U.S. Application Data
(63) Continuation of application No. PCT/CN2012/076884, filed on Jun. 14, 2012.

(30) Foreign Application Priority Data
Sep. 13, 2011 (CN) 201110269300.6

(51) Int. Cl. G06F 17/30

(52) U.S. Cl. CPC G06F 17/3053
USPC 707/749

(57) ABSTRACT

This document publishes a method and an apparatus of recommending popular accounts in a social network service (SNS) system. In one embodiment, the method includes the following steps: analyzing relating information of a specified user stored in a network system to get preference information of the specified user; querying popular accounts matched to the preference information from popular accounts stored in the SNS system; and outputting the popular accounts matched to the preference information as recommended popular accounts for the specified user. According to the method and apparatus, t is possible to recommend popular accounts for each registered user in the SNS system with a personalized manner, and the recommended popular accounts can be pushed to the user after the user logins the SNS system. As the recommended popular accounts are very close to the preference of the user, the activity of the SNS system is significantly improved.

This application is a U.S. continuation application under 35 U.S.C. §111(a) claiming priority under 35 U.S.C. §120 and 365(c) to International Application No. PCT/CN2012/076884 filed Jun. 14, 2012, which claims priority of a Chinese patent application serial No. 201110269300.6, titled “method and apparatus of recommending popular accounts in an SNS system” and filed on Sep. 13, 2011, the contents of which are incorporated by reference herein in their entirety for all intended purposes.

### FIELD OF THE DISCLOSURE

The present disclosure relates to network data processing technique, and more particularly to a method and an apparatus of recommending popular accounts in an SNS system (Social Network System).

### BACKGROUND

Micro-blog is a user relationship based network platform for sharing, broadcasting, and obtaining information. Users may access a micro-blog system using a client terminal via a cable communication network or a wireless communication network, write micro-blog posts containing texts of a length less a certain value and/or other multimedia information, and share the posts immediately.

With the further popularization of the internet, the micro-blog systems grows rapidly, and some micro-blog system have more than 100 million registered users now. A feature of micro-blog system is that there are many popular accounts from various fields, and users may easily interact with these popular accounts. As the number of the popular accounts grows, it is necessary to provide a more effective method for recommending these popular accounts to users.

In a known micro-blog system, a method of recommending popular accounts is achieved by manually editing. However, this method consumes a lot of labor costs and suffers from low efficiency. Furthermore, this method strongly depends on editors' subjective will, and it is impossible to achieve personalized and accurate recommendation for the users. As a result, the recommended popular accounts are usually not met to the user's preference.

### SUMMARY

This disclosure provides a method and an apparatus of recommending popular accounts in an SNS system. The method and apparatus can reduce the labor costs, improve the efficiency and provide recommended popular accounts approaching to the user's preference.

In one embodiment, a method of recommending popular accounts in an SNS system includes the following steps: analyzing relating information of a specified user stored in a network system to get preference information of the specified user; querying popular accounts matched to the preference information from popular accounts stored in the SNS system; and outputting the popular accounts matched to the preference information as recommended popular accounts for the specified user.

In another embodiment, an apparatus of recommending popular accounts in an SNS system includes memory and one or more processors. The apparatus further includes an analyzing module, a querying module, and a recommending module, stored in the memory and configured for execution by the one or more processors. The analyzing module is configured for analyzing relating information of a specified user stored in a network system to get preference information of the specified user; The querying module is configured for querying popular accounts matched to the preference information from popular accounts stored in the SNS system; and the recommending module is configured for outputting the popular accounts matched to the preference information as recommended popular accounts for the specified user.

### BRIEF DESCRIPTION OF THE DRAWINGS

To illustrate the technical solution according to embodiments of the present disclosure more clearly, drawings to be used in the description of the embodiments are described in brief as follows. However, the drawings described herein are for illustrative purposes only of selected embodiments and not all possible implementations, and are not intended to limit the scope of the present disclosure. Corresponding reference numerals indicate corresponding parts throughout the several views of the drawings.

FIG. 1 illustrates a runtime environment according to some embodiments.

FIG. 2 is a block diagram illustrating a server according to an embodiment.

FIG. 3 is a flow chart of a method of recommending popular accounts for a specified user in an SNS system according to an embodiment.

FIG. 4 is a schematic view illustrating a data flow of the method in accordance with an embodiment.

FIG. 5 is a schematic view illustrating the popular accounts recommending module in FIG. 2 according to an embodiment.

FIG. 6 is a block diagram of the analyzing module in FIG. 5 according to an embodiment.

FIG. 7 is a block diagram of the querying module in FIG. 5 according to an embodiment.

### PREFERRED EMBODIMENTS

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments.

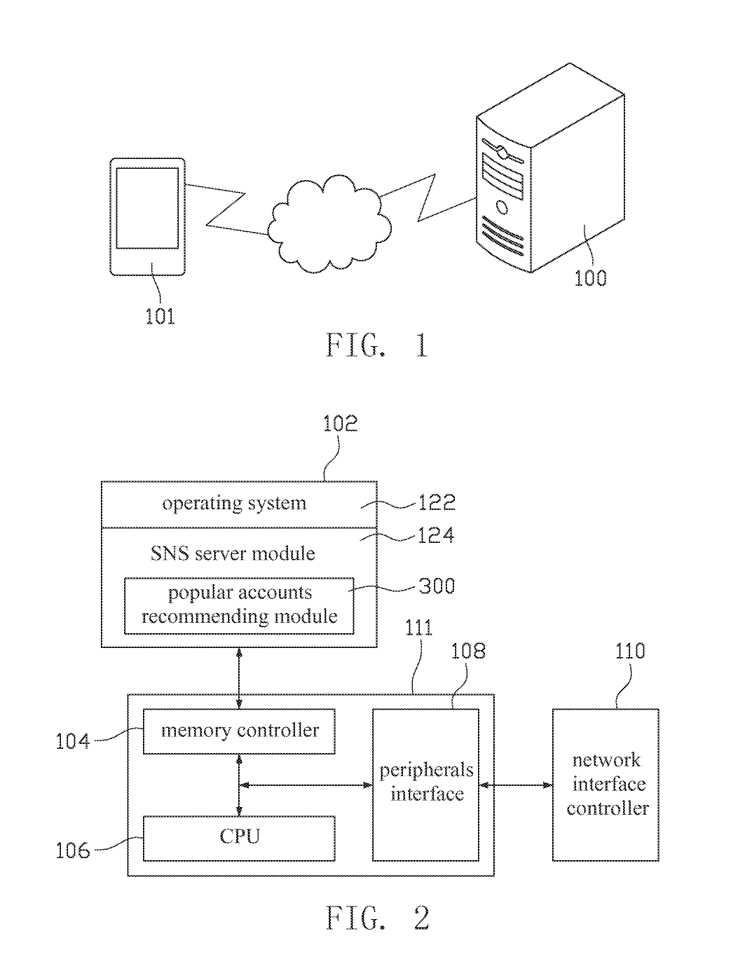

FIG. 1 illustrates a runtime environment according to some embodiments. A client 101 is connected to an SNS server 100 via a network such as internet or mobile communication network. Examples of the client 101 includes, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to those skilled in the art.

A browser or an application may be installed in the client, and the user of the client 101 may access the SNS (i.e., a micro-blog system) provided by the server 100 using the browser or the application.

FIG. 2 illustrates the server 100, according to some embodiments of the disclosure. The server 100 includes a memory 102, a memory controller 104, one or more processing units (CPU's) 106, a peripherals interface 108, and a network interface controller 110. These components communicate over the one or more communication buses or signal lines 112. It should be appreciated that the server 100 is only one example of a server, and that the server 100 may have more or fewer components that shown, or a different configuration of components. The various components shown in FIG. 2 may be implemented in hardware, software or a combination of both hardware and software, including one or more signal processing and/or application specific integrated circuits.

The memory 102 may include high speed random access memory and may also include non-volatile memory, such as one or more magnetic disk storage devices, flash memory devices, or other non-volatile solid state memory devices. In some embodiments, the memory 102 may further include storage remotely located from the one or more processors 106, for instance network attached storage accessed via network interface controller 110 and a communications network (not shown) such as the Internet, intranet(s), Local Area Networks (LANs), Wireless Local Area Networks (WLANs), Storage Area Networks (SANs) and the like, or any suitable combination thereof. Access to the memory 102 by other components of the server 100, such as the CPU 106 and the peripherals interface 108 may be controlled by the memory controller 104.

The peripherals interface 108 couples the input and output peripherals of the device to the CPU 106 and the memory 102. The one or more processors 106 run various software programs and/or sets of instructions stored in the memory 102 to perform various functions for the server 100 and to process data.

In some embodiments, the peripherals interface 108, the CPU 106, and the memory controller 104 may be implemented on a single chip, such as a chip 111. In some other embodiments, they may be implemented on separate chips.

The network interface controller 110 receives and sends network signals. The network interface controller 110 converts electrical signals/optical signals/electromagnetic waves and communicates with other devices such as other servers or routers. As such, the server 100 may receive a web request through the network interface controller 110 and send data to a client using the network interface controller 110.

In some embodiments, there are software components stored in the memory 102. For example, the software components include an operating system 122, and an SNS server module 124.

The operating system 122 (e.g., Darwin, RTXC, LINUX, UNIX, OS X, WINDOWS) includes various software components and/or drivers for controlling and managing general system tasks (e.g., memory management, storage device control, power management, etc.) and facilitates communication between various hardware and software components.

The SNS server module 124 is the serve side program run on the operating system 122. The SNS server module 124 receives web requests from clients, for example, the client 101 in FIG. 1, and return processing results of the web request to the clients. The processing results may include texts, images, videos, and audios.

According to some embodiments, the SNS server module 124 includes a popular accounts recommending module 300. The popular accounts recommending module 300 automatically recommends popular accounts for the user of the SNS system, and the detail mechanism of the popular accounts recommending module 300 is described in the following context.

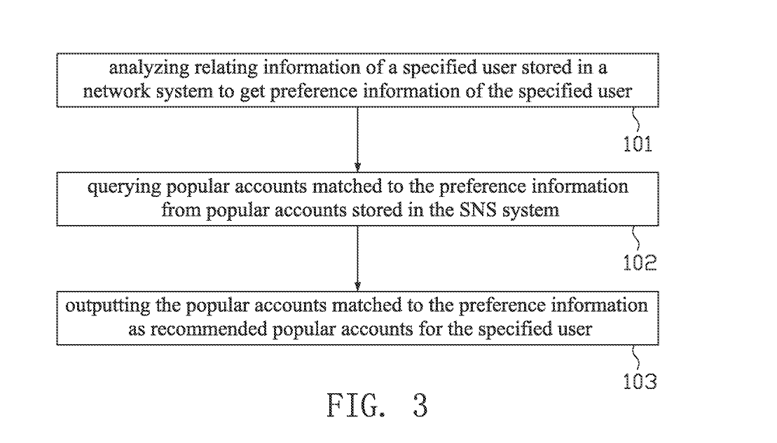

FIG. 3 illustrates a method of recommending popular accounts for a specified user in accordance with a first embodiment. Referring to FIG. 3, the method includes the following steps.

Step 101, analyzing relating information of a specified user stored in a network system to get preference information of the specified user;

Step 102, querying popular accounts matched to the preference information from popular accounts stored in the SNS system;

Step 103, outputting the popular accounts matched to the preference information as recommended popular accounts for the specified user.

The network system, for example, is a social network service (SNS) system (e.g., a Micro-blog system), and may further include other associated web-based systems. The specified user, for example, is a registered user (e.g., user AAA or user BBB) of the SNS system. The SNS system may perform the method of the present embodiment for each registered user to obtain a recommended popular accounts list for each registered user. As a result, personalized recommending of popular accounts according to different interests and preference of different users is achieved. Each popular account can be represented by a user identifier (e.g., a username or nickname), and what the method provides for the specified user may be a list of nicknames.

In one embodiment, the step 101 is achieved by the following steps: analyzing the relating information of the specified user to extract words of interest fields; weighting the words of interest fields, wherein each particular word of interest fields is given a weight according to a category of particular relating information, from which the particular word of interest fields is extracted; and sorting all the words of interest fields by the sum of the weight for each particular word of interest fields to obtain a list of interest fields as the preference information.

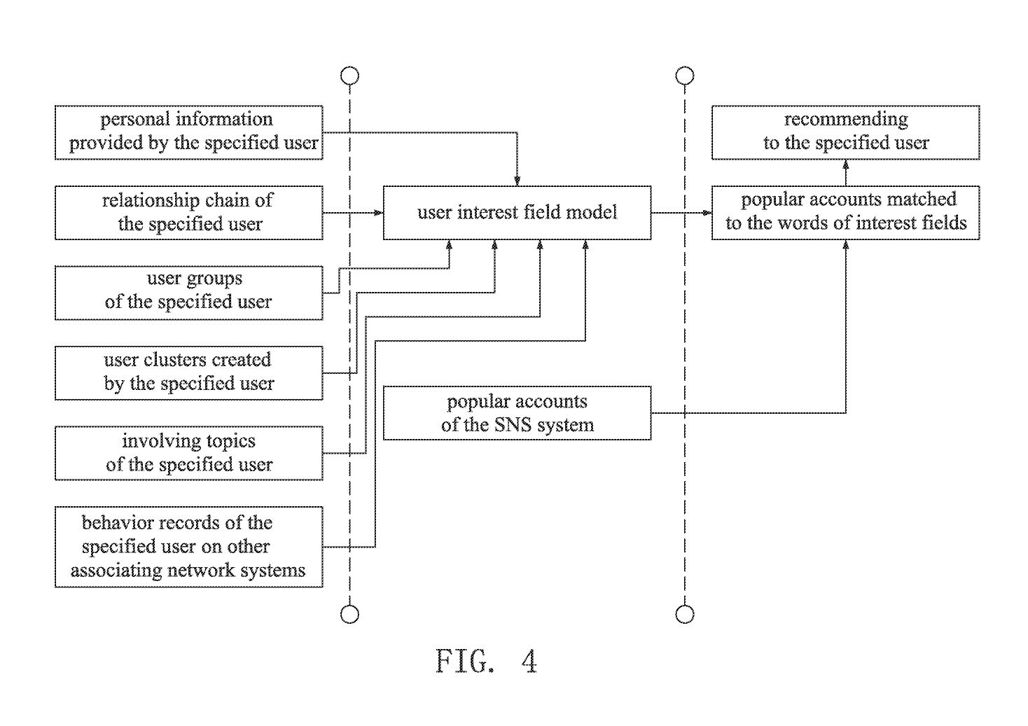

FIG. 4 is a schematic view illustrating a data flow of the method in accordance with an embodiment. Referring to FIGS. 1 and 2, in step 101, the relating information includes any combination of information of the following categories: personal information provided by the specified user; relationship chain of the specified user; involving topics of the specified user; user groups of the specified user; user accounts followed or listened by the specified user; and blog published by the specified user on an relating network system. It is to be noted that information of each category may have a particular structure, thus the words of interest fields can be extracted using a manner corresponding to a specific category of the relating information.

A) The personal information provided by the specified user, for example, includes registration information of user such as gender, age, hometown, interests and etc. Words of interest fields such as hometown and interests can be directly extracted from the personal information.

B) The relationship chain of the specified user, for example, includes the records of popular accounts that are followed or listened by the user in the SNS system. By analyzing the popular accounts that are already followed or listened by the user, the interest fields, to which the popular accounts followed or listened by the user mainly belong, can be summarized through statistics. Then, the interest fields can be sorted by the popularity thereof, and a specified number of words of the interest fields that having top ranking can be extracted. The specified number can be configured according to practical requirements.

C) The involving topics of the specified user, for example, include discussing topics in the SNS system. The user may participate in these topics according to their interests. By analyzing the fields, in which the involving topics of the specified user participates, words of interest fields that appears over specified times can be summarized by statistics, or a specified number of words of interest fields that have a top ranking of appearance times can be summarized by statistics. The specified times and the specified number can be configured according to practical requirements.

D) The user groups of the specified user, for example, include user syndicates of the SNS system. In the user syndicates, the specified user may find like-minded people. Like-minded people, for example, means they have a common interest, belong to a same fans group, study in or graduated from a same school, or have a same job. The user may discuss various topics with other users in the user syndicates. By analyzing the common interest of the user syndicates, words of interest fields that appears over specified times can be summarized by statistics, or a specified number of words of interest fields that have a top ranking of appearance times can be summarized by statistics. The specified times and the specified number can be configured according to practical requirements.

E) The user clusters created by the specified user, for example, are lists of user accounts that the specified user follows or listens. The specified user could classify the user accounts into different categories, or add the user accounts into different lists such as colleague list, friend list, sports list, entertainment list and etc. By analyzing the topics or description of the user clusters, words of interest fields that appears over specified times can be summarized by statistics, or a specified number of words of interest fields that have a top ranking of appearance times can be summarized by statistics. The specified times and the specified number can be configured according to practical requirements.

F) The behavior records of the specified user on other associating network systems, for example, include listening records in an associating music websites, or browsing records of news in a news website. The relating websites are websites that can be logged in with the user accounts of the SNS system. By analyzing the behavior records of the specified user, words of interest fields that appears over specified times can be summarized by statistics, or a specified number of words of interest fields that have a top ranking of appearance times can be summarized by statistics. The specified times and the specified number can be configured according to practical requirements. For example, an account of a musician that the specified user interests in can be obtained by analyzing behavior records in an associating music websites.

In step 101, an identifier (usually is account name) in the SNS system can be used to query the relating information from a corresponding data source (e.g., a database). Then, analyzing methods corresponding to the above information categories are performed to extract the words of interest fields.

The above described relating information A), in other words, the personal information provided by the specified user, is explicit user feedback information, and can accurately show the real interest of the specified user to certain fields. However, it is necessary to consume the user's energy to provide the personal information. The above relating information B) to F) is implicit user feedback information, which implicitly shows the interest of the specified user to certain fields. Analyzing process corresponding to the categories of the relating information is required to extract the words of interest fields. For implicit user feedback information, the method according to an embodiment may further analyze the relating information to obtain behavioral characteristics information and ascertain words of interest fields corresponding to the behavioral characteristics information. For example, if the latest published Micro-blog posts of the specified user are all children-related, and uploaded photos and videos are relating to his child, it is reasonable to conclude that the specified user could be interested in children-related things such as children education and children medical care according to pre-configured inference strategies. The inference strategies, for example, are correspondence between keywords and the words of interest fields. The correspondence can be stored in a file or a database.

After extracting the words of interest fields of the specified user from the relating information, it is necessary to weight the words of interest fields according to the weight of the corresponding categories. Then, all the extracted words of interest fields are sorted by the sum of the weight for each particular word to obtain a sorted list of words of interest fields. Each word in the sorted list has a total weight. The sorted list is also an interest field model, and the interest field model is employed as the preference information of the specified user according to an embodiment.

The above relating information A) to F) each has a corresponding weight. For example, the personal information provided by the specified user has a relatively high weight. For information that is not directly provided by the specified user but is produced from the specified user's active behavior, for example, the relationship chain actively created by the user, and user groups that the user actively participates in, also has a relatively high weight. The information obtained from other associating websites has a relatively low weight.

For example, the personal information provided by the specified user may have a weight of 50; the relationship information of the specified user has a weight of 20; and the blog recording information of the specified user in other associating network systems has a weight of 10. Taking the relating information of the user AAA as an example, two words of interest fields, “soccer” and “finance”, are extracted from the personal information thereof, thus these two words are each given a weight of 50. If the word of interest field “finance” is also extracted from the relationship chain information of the user AAA, the word “finance” should be given a plus weight of 20. If a word of interest field “Oscar” is extracted from blog records in an associating network system, the words “Oscar” should be given a weight of 10. Then, the sum of the weight for each word of interest field can be calculated, and all the words of interest fields can be sorted the sum thereby obtaining a sorted list of words of interest fields.

In addition, user clicking information of recommended popular accounts of different categories of the relating information can be further gathered, and the weight of each category for the specified user can be adjusted according to the clicking information.

According to an embodiment, the step 102 includes the following steps. First, the popular accounts are tagged, and this can be done manually or by computer programs. Then, the popular accounts are classified according to the tags thereof, and a mapping between the tags and the preference information is set. The mapping relation can be stored in the SNS system. After that, tags matched to the preference information that is ascertained in step 101 is queried according to the mapping, popular accounts met specified conditions can be selected from the popular accounts group that is corresponding to the tags, and the selected popular accounts is the querying result of the step 102.

The preference information includes one or more words of interest fields, and each of the words of interest fields is corresponding to one or more tags. For example the word of interest fields “soccer” could corresponds to tags such as “national soccer team”, “Italian Serie A”, “FA Premier League”, “Planet World Cup-Legends” and etc. Each tag is corresponding to a popular accounts pool, in other words, a popular accounts group which includes a list of user identifiers (e.g., the name) of popular people. The list of user identifiers can be ordered by the popularity. The specified conditions can be pre-configured or modified according to practical applications, and it is not limited according to this embodiment. For example, according to some embodiments, the specified conditions are that top two popular accounts should be selected from each popular accounts group corresponding to each tag. If the preference information of the user AAA includes a word of interest field “soccer”, tags “national soccer team”, “Italian Serie A”, “FA Premier League”, and “Planet World Cup-Legends” could be queried according to the mapping. Then, two popular accounts having highest popularity could be selected for each popular accounts pool corresponding to each tag as the querying result. The querying result is employed as the recommended popular accounts for the user AAA.

In addition, the preference information of the user AAA may include more than one word of interest field. For example, the preference information may include a list of words of interest fields. Then, in step 102, tags corresponding to each of the words should be queried to select the popular accounts met specified conditions. The all the popular accounts can be sorted according to a predetermined order and popular accounts having rankings in a specified range (e.g., top ten) can be selected as the recommended popular accounts for the user AAA. For example, the popular accounts can be sorted by the sum of the weight of each word, or by the weighted average of the sum and popularity of the corresponding popular accounts. For example, the word A has a weight of 50, and two popular accounts, account A and account B, corresponding to the word A are selected. The popularity of a popular account can be indicated by its followers, and the number of followers can be transformed into a popularity index according to a certain rule. It is to be understood that the popularity index is proportional to the number of followers. For example, the account A has 10 million followers while the account B has 5 million followers. If the account A has a popularity index of 100, then the account B has a popularity index of 50. According to some embodiments, the weight of the word and the popularity index are given weights of 50% and 50%, respectively. Then, a weighted average for the account A could be calculated according to the following formula: 50*50%+100*50%=75, and a weighted average for the account B could be calculated according to the following formula: 50*50%+50*50%=50.

Besides the above method of recommending popular accounts, other embodiments also provides an apparatus of recommending popular accounts in an SNS system. For example, as shown in FIG. 2, the apparatus can be the server 100.

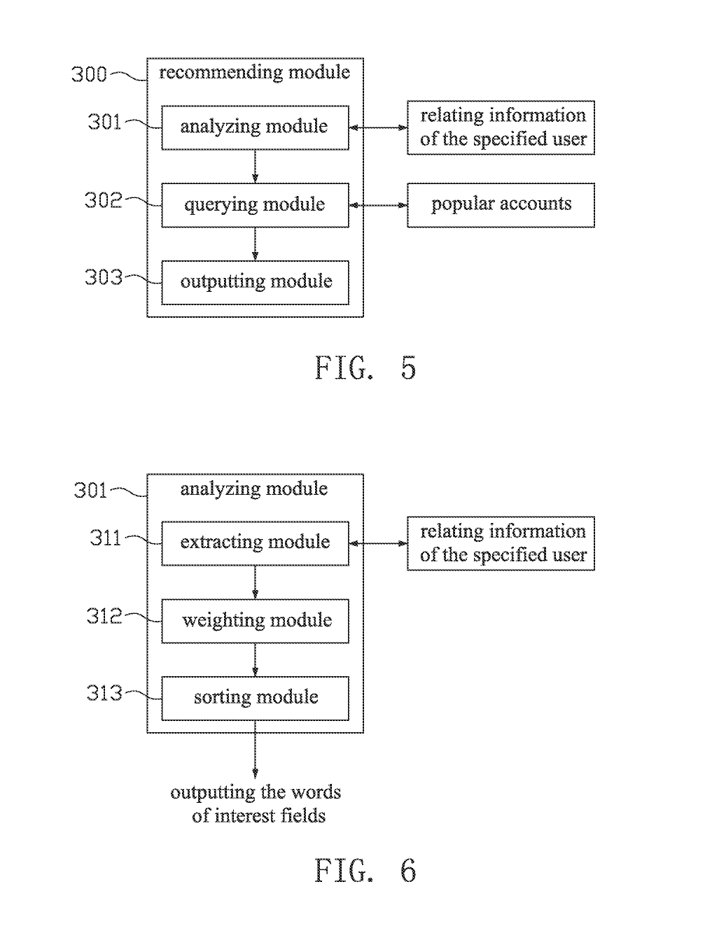

FIG. 5 is a schematic view illustrating the popular accounts recommending module 300 according to an embodiment. Referring to FIG. 5, the popular accounts recommending module 300 includes an analyzing module 301, a querying module 302, and an outputting module 303.

The analyzing module 301 is configured for analyzing relating information of a specified user stored in a network system to get preference information of the specified user.

The querying module 302 is configured for querying popular accounts matched to the preference information from popular accounts stored in the SNS system.

The outputting module 303 is configured for outputting the popular accounts matched to the preference information as recommended popular accounts for the specified user.

FIG. 6 is a block diagram of the analyzing module 301 according to some embodiments. Referring to FIG. 6, the analyzing module 301 includes an extracting module 311, a weighting module 312, and a sorting module 313.

The extracting module 311 is configured for analyzing the relating information of the specified user to extract words of interest fields.

The weighting module 312 is configured for weighting the words of interest fields, wherein each particular word of interest is given a weight according to a category of particular relating information, from which the particular word of interest is extracted.

The sorting module 313 is configured for sorting all the words of interest fields by the sum of the weight for each particular word of interest to obtain a list of interest fields as the preference information.

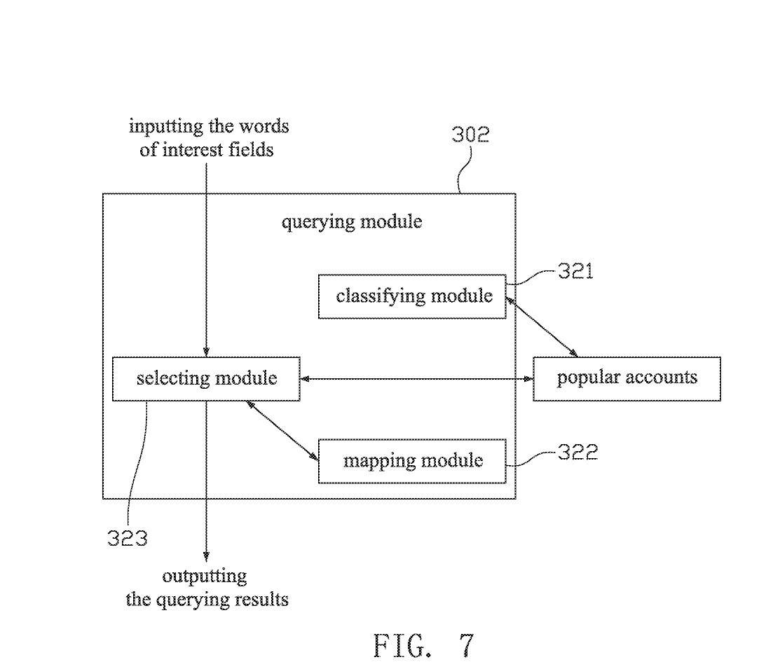

FIG. 7 is a block diagram of the querying module 302 according to some embodiments. Referring to FIG. 6, the querying module 302 includes a classifying module 321, a mapping module 322, and a selecting module 323.

The classifying module 321 is configured for classifying the popular accounts stored in the SNS system into popular account groups according to tags of these popular accounts.

The mapping module 322 is configured for configuring a mapping between tags and preference information.

The selecting module 323 is configured for obtaining tags corresponding to the preference information of the specified user; and selecting popular accounts met specified conditions from the popular account groups matched to obtained tags as the recommended popular accounts for the specified user.

According to above embodiments, it is possible to recommend popular accounts for each registered user in the SNS system with a personalized manner using the method and apparatus, and the recommended popular accounts can be pushed to the user after the user logins the SNS system. As the recommended popular accounts are very close to the preference of the user, the activity of the SNS system is significantly improved.

The contents described above are only preferred embodiments of the present disclosure, but the scope of the present disclosure is not limited to the embodiments. Any ordinarily skilled in the art would make any modifications or replacements to the embodiments in the scope of the present disclosure, and these modifications or replacements should be included in the scope of the present disclosure. Thus, the scope of the present disclosure should be subjected to the claims.

### INDUSTRIAL APPLICABILITY AND ADVANTAGEOUS EFFECTS

The method and apparatus according to above embodiments get the preference information of the users by analyzing relating information thereof, query popular accounts matched to the preference information, and recommend the queried popular accounts to the user. As a result, the recommending of popular accounts can be automatically achieved using a data processing device. The labor cost is reduced, and the recommending efficiency is improved. In addition, the method and apparatus provide personalized popular accounts recommending result to the user, and thus the recommending result is more close to the use's preference.

It is possible to recommend popular accounts for each registered user in the SNS system with a personalized manner using the method and apparatus, and the recommended popular accounts can be pushed to the user after the user logins the SNS system. As the recommended popular accounts are very close to the preference of the user, the activity of the SNS system is significantly improved.

What is claimed is:

1. A method of recommending popular accounts in a social network service (SNS) system, the method comprising:
analyzing relating information of a specified user stored in a network system to get preference information of the specified user;
querying popular accounts matched to the preference information from popular accounts stored in the SNS system; and
outputting the popular accounts matched to the preference information as recommended popular accounts for the specified user.

2. The method of claim 1, wherein the analyzing comprises:
analyzing the relating information of the specified user to extract words of interest fields;
weighting the words of interest fields, wherein each particular word of interest is given a weight according to a category of particular relating information, from which the particular word of interest is extracted; and
sorting all the words of interest fields by the sum of the weight for each particular word of interest to obtain a sorted list of interest fields as the preference information.

3. The method of claim 2, wherein the analyzing the relating information of the specified user to extract words of interest fields comprises:
extracting the words of interest fields directly from the relating information of the specified user; and/or
analyzing the relating information to find out words of interest fields that appears over specified times or have a popularity exceeding a predetermined value; and/or
analyzing the relating information to obtain behavioral characteristics information and ascertain words of interest fields corresponding to the behavioral characteristics information.

4. The method of claim 2, wherein the method further comprises:
gathering user clicking information of recommended popular accounts of different categories of the relating information; and
adjusting the weight of the category for the specified user according to the clicking information.

5. The method of claim 1, wherein the relating information comprises any combination of: personal information provided by the specified user; relationship chain of the specified user; involving topics of the specified user; user groups of the specified user; user clusters created by the specified user; and behavior records of the specified user on other associating network systems.

6. The method of claim 1, where the querying comprises:
classifying the popular accounts stored in the SNS system into popular account groups according to tags of these popular accounts;
configuring a mapping between tags and preference information;
obtaining tags corresponding to the preference information of the specified user; and
selecting popular accounts met specified conditions from the popular account groups matched to obtained tags as the recommended popular accounts for the specified user.

7. The method of claim 1, wherein after the querying, the method further comprises: sorting the popular accounts matched to the preference information by a predetermined order;
the outputting comprising: selecting popular accounts having a ranking in a predetermined range as the recommended popular accounts for the specified user.

8. An apparatus of recommending popular accounts in a social network service (SNS) system, the apparatus comprising:
an analyzing module, configured for analyzing relating information of a specified user stored in a network system to get preference information of the specified user;
an querying module, configured for querying popular accounts matched to the preference information from popular accounts stored in the SNS system; and
an outputting module, configured for outputting the popular accounts matched to the preference information as recommended popular accounts for the specified user.

9. The apparatus of claim 8, wherein the analyzing module comprises:
an extracting module, configured for analyzing the relating information of the specified user to extract words of interest fields;
a weighting module, configured for weighting the words of interest fields, wherein each particular word of interest is given a weight according to a category of particular relating information, from which the particular word of interest is extracted; and
a sorting module, configured for sorting all the words of interest fields by the sum of the weight for each particular word of interest to obtain a list of interest fields as the preference information.

10. The apparatus of claim 8, wherein the querying module comprises:
a classifying module, configured for classifying the popular accounts stored in the SNS system into popular account groups according to tags of these popular accounts;
a mapping module, configured for configuring a mapping between tags and preference information; and
a selecting module, configured for obtaining tags corresponding to the preference information of the specified user; and selecting popular accounts met specified conditions from the popular account groups matched to obtained tags as the recommended popular accounts for the specified user.

11. A server, configured for being applied in a social network service (SNS) system, the server comprising:
a memory;
one or more processors; and
one or more modules stored in the memory and configured for execution by the one or more processors, the one or more modules comprising instructions:
to analyze relating information of a specified user stored in a network system to get preference information of the specified user;
to query popular accounts matched to the preference information from popular accounts stored in the SNS system; and
to output the popular accounts matched to the preference information as recommended popular accounts for the specified user.

12. The server of claim 11, wherein the instructions to analyze relating information comprise instructions:
to analyze the relating information of the specified user to extract words of interest fields;
to weight the words of interest fields, wherein each particular word of interest is given a weight according to a category of particular relating information, from which the particular word of interest is extracted; and
to sort all the words of interest fields by the sum of the weight for each particular word of interest to obtain a sorted list of interest fields as the preference information.

13. The server of claim 12, wherein the instructions to analyze the relating information of the specified user to extract words of interest fields comprise instructions:
to extract the words of interest fields directly from the relating information of the specified user; and/or
to analyze the relating information to find out words of interest fields that appears over specified times or have a popularity exceeding a predetermined value; and/or
to analyze the relating information to obtain behavioral characteristics information and ascertain words of interest fields corresponding to the behavioral characteristics information.

14. The server of claim 12, wherein the one or more modules further comprise instructions:
to gather user clicking information of recommended popular accounts of different categories of the relating information; and
to adjust the weight of the category for the specified user according to the clicking information.

15. The server of claim 11, wherein the relating information comprises any combination of: personal information provided by the specified user; relationship chain of the specified user; involving topics of the specified user; user groups of the specified user; user clusters created by the specified user; and behavior records of the specified user on other associating network systems.

16. The server of claim 11, where the instructions to query popular accounts comprise instructions to:
to classify the popular accounts stored in the SNS system into popular account groups according to tags of these popular accounts;
to configure a mapping between tags and preference information;
obtaining tags corresponding to the preference information of the specified user; and
to select popular accounts met specified conditions from the popular account groups matched to obtained tags as the recommended popular accounts for the specified user.

17. The server of claim 11, wherein the one or more modules further comprises instructions configured for execution after the instructions to query popular accounts: to sort the popular accounts matched to the preference information by a predetermined order;
the instructions to output the popular accounts comprising instructions: to select popular accounts having a ranking in a predetermined range as the recommended popular accounts for the specified user.
